(19) United States
(12) Patent Application Publication
(10) Pub. No.: US 2024/0305800 A1
(43) Pub. Date: Sep. 12, 2024

(54) INTELLIGENT VIDEO EXPORT

(71) Applicant: Microsoft Technology Licensing, LLC, Redmond, WA (US)

(72) Inventors: Soeren BALKO, Brisbane (AU); Matt Jacob BIRMAN, Melbourne (AU); Joshua DUCK, Brisbane (AU)

(73) Assignee: Microsoft Technology Licensing, LLC, Redmond, WA (US)

(21) Appl. No.: 18/120,289

(22) Filed: Mar. 10, 2023

(51) Int. Cl. H04N 19/42; H04N 19/136; H04N 19/172; H04N 19/85

(52) U.S. Cl. CPC H04N 19/42; H04N 19/136; H04N 19/172; H04N 19/85

(57) ABSTRACT

A computer-implemented method includes receiving an encoded video input file comprising a plurality of video frames arranged in a timeline, receiving one or more video artifacts at respective time offsets along the timeline, generating a synthesized video stream based on the encoded video input file and the one or more video artifacts, and exporting the synthesized video stream into an encoded video output file. Generating the synthesized video stream includes identifying first and second segments of video frames along the timeline based at least in part on the time offsets of the one or more video artifacts, decoding the second segments of video frames, generating composite segments of video frames by combining the decoded second segments of video frames with corresponding video artifacts, encoding the composite segments of video frames, and concatenating the first segments of video frames and the encoded composite segments of video frames along the timeline.

### BACKGROUND

Video editing is the process of combining elements such as media assets (e.g., videos, images, audio, vector graphics, 3D scene renderings, etc.) and effects (e.g., filters, transitions, motion titles, overlays, etc.) on a timeline. The final step of video editing process is video export, which saves the edited video into a video file having a desired format for playback on different devices and platforms. Video export is computing intensive because it involves several resource-intensive processes, including decoding, compression, and encoding. Thus, there exists ample opportunity for improvement in technologies related to video export.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Certain aspects of the disclosure concern a computer-implemented method for video export. The method can include receiving an encoded video input file comprising a plurality of video frames arranged in a timeline; receiving one or more video artifacts at respective time offsets along the timeline; generating a synthesized video stream based on the encoded video input file and the one or more video artifacts; and exporting the synthesized video stream into an encoded video output file. The one or more video artifacts can change visual appearance of the video frames at the respective time offsets when the video frames are replayed. In certain examples, generating the synthesized video stream can include identifying first segments of video frames and second segments of video frames along the timeline based at least in part on the time offsets of the one or more video artifacts; decoding the second segments of video frames; generating composite segments of video frames by combining the decoded second segments of video frames with corresponding video artifacts; encoding the composite segments of video frames; and concatenating the first segments of video frames and the encoded composite segments of video frames along the timeline to generate the synthesized video stream. The first segments of video frames are directly extracted from the encoded video input file without being decoded.

Certain aspects of the disclosure also concern a computing device including memory, one or more hardware processors coupled to the memory, and one or more computer readable storage media storing instructions that, when loaded into the memory, cause the one or more hardware processors to perform operations for video export. The operations can include receiving an encoded video input file comprising a plurality of video frames arranged in a timeline; receiving one or more video artifacts at respective time offsets along the timeline; generating a synthesized video stream based on the encoded video input file and the one or more video artifacts; and exporting the synthesized video stream into an encoded video output file. The one or more video artifacts can change visual appearance of the video frames at the respective time offsets when the video frames are replayed. In some examples, generating the synthesized video stream can include identifying first segments of video frames and second segments of video frames along the timeline based at least in part on the time offsets of the one or more video artifacts; decoding the second segments of video frames; generating composite segments of video frames by combining the decoded second segments of video frames with corresponding video artifacts; encoding the composite segments of video frames; and concatenating the first segments of video frames and the encoded composite segments of video frames along the timeline to generate the synthesized video stream. The first segments of video frames are directly extracted from the encoded video input file without being decoded.

Certain aspects of the disclosure further concern one or more non-transitory computer-readable media having encoded thereon computer-executable instructions causing one or more processors to perform a method for video export. The method includes receiving an encoded video input file comprising a plurality of video frames arranged in a timeline; receiving one or more video artifacts at respective time offsets along the timeline; generating a synthesized video stream based on the encoded video input file and the one or more video artifacts; and exporting the synthesized video stream into an encoded video output file. The one or more video artifacts can change visual appearance of the video frames at the respective time offsets when the video frames are replayed. In some examples, generating the synthesized video stream can include identifying first segments of video frames and second segments of video frames along the timeline based at least in part on the time offsets of the one or more video artifacts; in a first signal path, decoding the second segments of video frames; generating composite segments of video frames by combining the decoded second segments of video frames with corresponding video artifacts; and encoding the composite segments of video frames; in a second signal path, retrieving the first segments of video frames directly from the encoded video input file without decoding the same; and concatenating the first segments of video frames and the encoded composite segments of video frames along the timeline to generate the synthesized video stream.

As described herein, a variety of other features and advantages can be incorporated into the technologies as desired.

### BRIEF DESCRIPTION OF THE DRAWINGS

FIG. 1 is a block diagram depicting an example intelligent video export system.

FIG. 2 is a schematic diagram depicting an example video editing project arranged along a timeline.

FIG. 3 is a flowchart of an example overall method for intelligent video editing.

FIG. 4 is a flowchart of an example overall method for selecting video export approaches.

FIG. 5 is a flowchart of an example method for segmenting video streams.

FIG. 6 is a diagram of an example computing system in which some described embodiments can be implemented.

FIG. 7 is an example mobile device that can be used in conjunction with the technologies described herein.

FIG. 8 is an example cloud-support environment that can be used in conjunction with the technologies described herein.

### DETAILED DESCRIPTION

### Overview of Video Editing

Video editing is the process of combining elements such as video assets (e.g., videos, images, audio, vector graphics, 3D scene renderings, etc.) and effects (e.g., filters, transitions, motion titles, overlays, etc.) on a timeline. The video assets can be contributed by human users (e.g., videos recorded on smartphones or other video recording devices), be sourced from a stock media library, be synthesized using artificial intelligence image and/or video generators, or originate from other sources. Video editing can be performed manually or automated.

The result of a video editing process is a timeline of a video project, which can be represented by a data structure that defines which video elements are shown at a given point in time and what alterations are applied to the video elements. For example, the timeline of a video project can define certain time offsets (or time markers) when a media file cuts in or out, can place a motion title (which can be an animated and/or graphically styled text label, etc.) on top of a video, can show a first video as a “picture-in-picture” on top of a second video, can fade two videos into one another by using a transition effect, etc. It is also common that for many time offsets on a timeline, an original video asset can be represented “as is” (i.e., in its original form) without any visual alterations or other items that partially or fully occlude the original video.

Usually at the last step of video editing, the timeline of a video project can be saved or exported into a container or video file that adheres to a prevalent container format (e.g., MP4, Web, AVI, etc.) and video and audio encoding standards (e.g., H.264, AV1, HEVC, VP9, etc. for video encoding, and AAC, MP3, AC-3, etc. for audio encoding). Generally, a container or video file includes audio and video tracks, captioning and video description, and metadata about the video such as author, titles/subtitles, copyright, license, duration, resolution, aspect ratio, bitrate, etc. As a result, the exported video file can be compatible with a wide range of video players (e.g., in HTML <video> tags on websites, on pre-installed video players on smartphones, desktop operating systems, smart TVs and other devices and/or software platforms, etc.).

### Overview of Conventional Approach for Video Export

Conventionally, exporting a video project's timeline involves three stages: a decoder stage, a compositor stage, and an encoder stage.

At the decoder stage, the constituent visual assets (e.g., videos, images, etc.) of a video project's timeline can be decoded into a sequence of raw pixel representations or video frames. Specifically, a video decoder can decompress encoded video files. The video decoder can be either software-based (i.e., a decoding software running on a CPU) or hardware-based (i.e., dedicated hardware on a GPU implementing a decoding algorithm).

At the compositor stage, the decoded video asset and synthetic artifacts, also referred to as “video artifacts” (e.g., motion titles, transitions, etc.) can be combined into a single composited stream of video frames. Specifically, a video compositor can iterate over the video project's timeline. For each time offset, the video compositor can request the matching decoded video frames generated by the video decoder and select the video asset(s) that are visible at that offset. The video compositor can further render and/or add synthetic artifacts to the decoded media, as per timeline configuration. The video compositor can be implemented either in software or hardware.

At the encoder stage, the stream of video frames that is produced by the video compositor can be converted, e.g., by a video encoder, into a compressed bitstream, compliant with a specific video encoding standard (e.g., H.264, etc.), which can be further wrapped into a container file that is compliant with a standard media format (e.g., MP4, etc.). Likewise, the video encoder can be software-based (e.g., an encoding software running on a CPU) or hardware-based (i.e., dedicated hardware on a GPU implementing an encoding algorithm).

Exporting a video project's timeline using the decoder-compositor-encoder pipeline described above is a resource-intensive process, which can affect compute resources (e.g., the number of CPU cycles required to run the involved algorithms, etc.) and data throughput (e.g., the volume of data that is repeatedly allocated, copied, and transferred through the computer's main and graphics memory, etc.). As a result, video export can take a long time, which can grow with the length of a video project. During the protracted export process of a long video project, the aforementioned resource requirements can also lead to greater power consumption and temporarily deteriorate the computer's responsiveness (e.g., reducing the computer's ability to run other tasks in parallel).

### Example Overview of Intelligent Video Export

As described herein, an intelligent video export system can use a hybrid video export approach to improve the efficiency of video export process. As described more fully below, the intelligent video export system uses the conventional decoder-compositor-encoder pipeline only for exporting selected segments of a video project's timeline, while using a pass-through shortcut to export other segments of the timeline. When the selected segments passing through the decoder-compositor-encoder pipeline represents a small fraction of the timeline, such a hybrid video export approach can substantially reduce the overall duration of video export.

Many long-form video projects do not use many varieties of video assets and do not make extensive use of synthetic artifacts, such as motion titles, transitions, etc. For instance, when editing a Microsoft Teams recording there is typically only a single media file, which is mostly shown “as is,” aside from being trimmed to relevant moments. As another example, when recordings of video game sessions (e.g., from XBOX, PCs, etc.) are subsequently edited, very often only light editing steps are applied, whereas for the bulk of the video project's timeline, the original recording footage is not modified.

The intelligent video export system described herein can optimize the video export process by skipping the decoder-compositor-encoder pipeline when possible. Specifically, for each time offset on a video project's timeline, it can be determined whether to export the corresponding video frame using the decoder-compositor-encoder pipeline or to directly pass through an encoded video frame from the original media file and insert it into the output video file “as is.” Such determination can be made based on several criteria, as described more fully below.

In the following, the intelligent video export system is described using examples to illustrate how an exported media file's video track is produced, which is typically more computing resource intensive than generating the media file's audio track, from a timeline structure of a video project. Nonetheless, it should be understood that the same principles described herein can also be applied for improving the efficiency of producing an audio track of a medial file. For example, some segments of an audio stream contained in the original media file that are not modified by the video editor can be directly copied (i.e., pass-through) to the audio stream of the output video file, whereas other segments of the audio stream that are modified by the video editor can go through an audio decoding, audio composition, and audio encoding process, and then concatenated with those pass-through audio segments in the output video file.

### Example Intelligent Video Export System

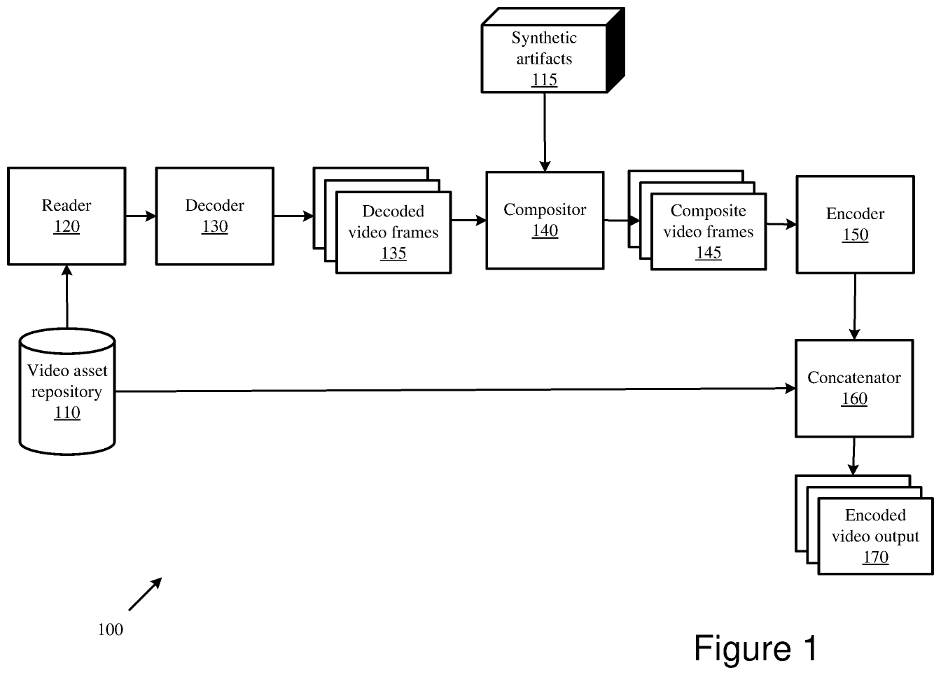

FIG. 1 shows a block diagram of an example intelligent video export system 100. The intelligent video export system 100 can be a part of, or in communication with, a video editing system configured to edit video content of various types of video assets.

The system 100 includes a reader 120 configured to retrieve a video file from a video asset repository 110, which can be stored in a persistent layer (e.g., hard drives, etc.) or an in-memory database. The video file retrieved by the reader 120 can have a variety of container formats, such as MP4, AVI, WMV, MOV, MKV, etc.

As shown in FIG. 1, the intelligent video export system 100 includes a decoder 130, a compositor 140, and an encoder 150. The decoder 130 can be configured to decode and decompress a video stream contained in the video file retrieved by the reader 120. The output of the decoder 130 includes a plurality of decoded video frames 135 arranged in a timeline. The compositor 140 can be configured to combine some of the decoded video frames 135 with corresponding synthetic artifacts 115 to generate composite video frames 145. The decoded video frames 135 fed to the compositor 140 can be limited to those decoded video frames that have been affected or modified by the synthetic artifacts 115. The synthetic artifacts 115 can be any visual effects generated by a video editor. Example visual effects include, but are not limited to, filters, color changes, texts, motion graphs/videos, animations, frame transitions, image manipulations (e.g., resize, rotation, flipping, etc.), replay speed variations, etc. The encoder 150 can be configured to compress and encode the composite video frames 145 into encoded video segments with a video format (or container format) that is compatible with a chosen export format. Thus, the output of the encoder 150 corresponds to segments of video frames that are affected or modified by the synthetic artifacts 115.

The intelligent video export system 100 can further include a concatenator 160. The concatenator 160 can be configured to retrieve selected segments of the video file (i.e., the same video file retrieved by the reader 120) directly from the video asset repository 110. The selected segments of the video file (which are already encoded) retrieved by the concatenator 160 can be limited to segments of video frames that are unaffected by the synthetic artifacts 115. The selected segments of the video file retrieved by the concatenator 160 do not overlap (along the timeline) with the encoded video segments output from the encoder 150. The concatenator 160 can be further configured to concatenate the selected segments of the video file retrieved from the video asset repository 110 with the encoded video segments output from the encoder 150 to generate a synthesized video stream or encoded video output 170, which can be saved as an output video file according to an export video format. In other words, the concatenator 160 can concatenate (or join) disjoint, adjacent video segments into a single, continuous video stream along the timeline.

Thus, the decoder 130, compositor 140, and encoder 150 can be selectively invoked only as needed, i.e., the decoder-compositor-encoder pipeline is active only for those segments of video frames that are affected by the synthetic artifacts 115. On the other hand, the selected segments of video frames unaffected by the synthetic artifacts 115 can be directly copied into the encoded video output 170, bypassing the resource-intensive sequence of decoding, compositing, and encoding. As a result, the video export can be performed by combining the pass-through shortcut (e.g., the direct data path between the video asset repository 110 and the concatenator 160) with the decoder-compositor-encoder pipeline in a single export run.

In practice, the systems and subsystems shown herein, such as system 100, can vary in complexity, with additional functionality, more complex components, and the like. For example, there can be additional functionality within the system 100. Additional components can be included to implement security, redundancy, load balancing, report design, and the like.

The described computing systems can be networked via wired or wireless network connections, including the Internet. Alternatively, systems can be connected through an intranet connection (e.g., in a corporate environment, government environment, or the like).

The system 100 and any of the other systems/subsystems described herein can be implemented in conjunction with any of the hardware components described herein, such as the computing systems described below (e.g., processing units, memory, and the like). In any of the examples herein, the video frames, synthetic artifacts, and the like can be stored in one or more computer-readable storage media or computer-readable storage devices. The technologies described herein can be generic to the specifics of operating systems or hardware and can be applied in any variety of environments to take advantage of the described features.

### Example Timeline and Synthetic Artifacts

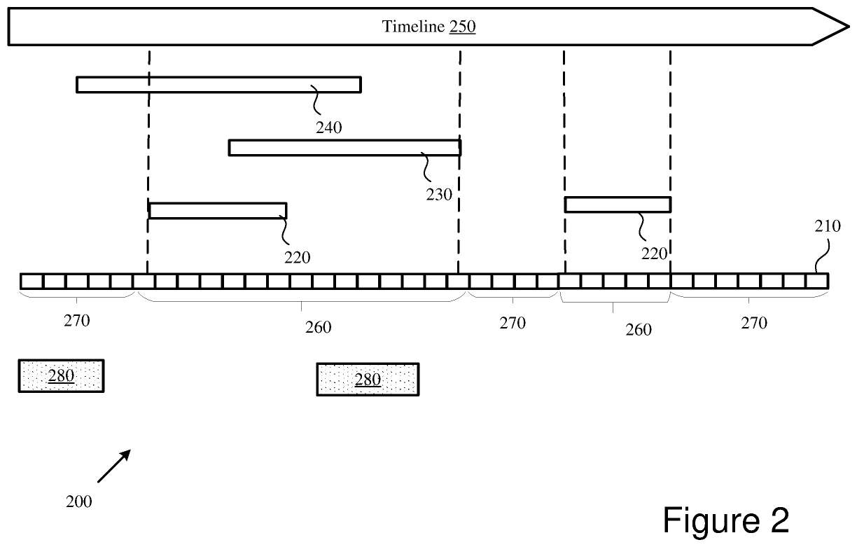

FIG. 2 is a schematic diagram depicting an example video project 200, which can be created and/or edited by a video editor. A video asset or input video file can be loaded into the video project 200. As shown, the video asset can include a plurality of video frames 210 arranged along a timeline 250 of the video project 200. Through the video editor, synthetic artifacts of different types can be added (e.g., by a user) to the video project 200.

In some examples, the synthetic artifacts can include one or more visible objects 220, which are added to the video project 200 at different time offsets of the timeline 250. The visible objects 220 can include videos, images, and/or texts that are shown on top of or overlie some of the video frames 210 such that the visible objects 210 can occlude at least a portion of the corresponding video frames 210. In other words, when the video project 200 is replayed, the visible objects 220 become part of the visual composition at corresponding time offsets. Some of the visible objects 220 can be imported from other media assets (e.g., another video file, etc.) by the video editor. Some of the visible objects 220 can be generated by the video editor itself (e.g., motion titles, frame transition effects, etc.).

As another example, the synthetic artifacts can include one or more visual modifiers 230, which can affect the visual appearance, but by themselves do not occlude, some of the video frames 210. Example visual modifiers 230 include filters applied to selected video frames (e.g., a sepia filter to create a sepia effect, etc.), a cropping operator to cut away margins of selected video frames, a change of opacity/transparency for selected video frames, a change of the playback speed for selected video frames, etc. When the video project 200 is replayed, the visual modifiers 230 can modify the visual appearance, but do not occlude video frames 210 at corresponding time offsets.

Notably, both the visible objects 220 and visual modifiers 230 can change certain visual aspects of the corresponding video frames. In other words, the original video file can be visually altered from their original representation at time offsets corresponding to the visual objects 220 or visual modifiers 230.

In the example depicted in FIG. 2, segments 260 of the video frames 210 can be identified to overlap with the time offsets of any visible objects 220 or any visual modifiers 230. Because the video frames included in the segments 260 are visually modified from their original representations in the input video file, during the intelligent video export process, the segments 260 of video frames will be processed by the decoder-compositor-encoder pipeline (e.g., the decoder 130, compositor 140, and encoder 150 of FIG. 1). The segments 260 can also be referred to as “modified segments.” Other segments 270 of video frames that are non-overlapping with the time offsets of either visible objects 220 or visual modifiers 230 can bypass the decoder-compositor-encoder pipeline. In other words, the segments of video stream corresponding to the segments 270 can be directly copied into the video output file. The segments 270 can also be referred to as “pass-through segments.”

In some examples, the video asset loaded into the video project 200 can be trimmed. For example, using a video editor, a user may trim off certain portions (e.g., beginning, end, and/or middle portions) of the video asset to reduce the overall length of the video before generating the video output file. The trimmed portions of the video asset can be defined by trim windows at specific time offsets (and with respective durations) alone the timeline. As an example, FIG. 2 shows two trim windows 280 located at different time offsets of the timeline 250. Any video frames 210 located within the trim windows 280 (which can also be referred to as “trimmed video frames”) can be removed before exporting to the video output file. In other words, trimmed video frames are removed from the segments 270 (i.e., there is no direct pass-through copying for trimmed video frames within segments 270), as well as from the segments 260 (i.e., there is no need to decode-compose-encode the trimmed video frames within segments 260).

Although in the examples described above, it is assumed that only one input video file is loaded into the video project 200 for editing, it should be understood that multiple video assets or input video files can be simultaneously loaded into the video project 200, and synthetic artifacts can be added to various portions of the multiple video assets. In such circumstances, segments that are overlapping with the time offsets of visible objects or visual modifiers, irrespective of which video asset the segments are part of, will be processed by the decoder-compositor-encoder pipeline. Similarly, segments that do not overlap with the time offsets of either visible objects or visual modifiers, irrespective of which video asset the segments are part of, can be directly copied from the original video assets to the video output file.

In some examples, one or more audio clips 240 can be added to the video project 200. Although the audio clips 240 can also be deemed as part of the synthetic artifacts, the audio clips 240 do not affect the visual appearance/scene of the video frames when the video project 200 is replayed. Thus, merely adding audio clips 240 to the video project 200, without more, generally does not involve the decoder-compositor-encoder pipeline described above. As such, even if some video frames in segments 270 overlap with the audio clips 240, these segments 270 can still be embedded into the video output file via the pass-through shortcut.

### Example Video Format Changes

In some circumstances, after editing a video file, a user may select to export the edit video into a different video format (e.g., container format) than that of the original video file. For example, the original video file can have an AVI container format whereas the exported video file may have an MP4 container format. As another example, the video stream used in the original video file may have one codec standard (e.g., H.261, etc.), whereas the video stream used in the exported video file may have a different codec standard (e.g., H.264, etc.). Other format differences between the input video file and exported video file can include, but are not limited to frame resolution (e.g., 1080p vs. 720p, etc.), aspect ratio (e.g., 16:9 vs. 4:3, etc.), frame rate (e.g., 30 fps vs. 24 fps, etc.), specific codec profiles (e.g., high vs. baseline or main in H.264 profile., etc.), and bitrate (e.g., 1 Mbps vs. 4 Mbps, etc.).

In some circumstances, the video format of the exported video file may be restricted. For example, the standard MP4 container format may only support the H.264 video codec standard, and the supported frame resolution, aspect ratio, bit rate, etc. may be limited. In other circumstances, the video format of the exported video file may be more flexible or accommodating. For example, the fragmented MP4 (fMP4) container format may contain multiple video streams having different frame resolutions, different bitrates, etc. As another example, certain container formats may support multiple video streams having different codec standards and/or codec profiles, etc.

In some examples, particularly when the video format of the exported video file is restricted, certain differences in the video format between the input video file and the exported video file can force all video frames of the input video file to be processed by the decoder-compositor-encoder pipeline. For example, after editing a video file, if the user choses to export the video in a video format that is different from that of the original video file (e.g., in terms of container format, codec standard, frame resolution, aspect ratio, bitrate, etc.), then all video frames of the video file will be decoded, combined with corresponding synthetic artifacts if any, and then encoded to generate the video stream in the output video file (i.e., no video frame directly passes through to the output video file). This means, e.g., for the example depicted in FIG. 2, the segments 270 are treated as the same as segments 260, even if the segments 270 do not overlap with the time offsets of any of the visible objects 220 or visual modifiers 230.

In other examples, particularly when the video format of the exported video file is more flexible, certain differences in the video format between the input video file and the exported video file may not affect the hybrid video export approach described above. For example, if the video format of the exported video file supports a different frame resolution than the input video file, than such a difference in video format between the input video file and the exported video file will not prevent direct pass-through of segments 270 of the input video stream to the video output file.

Thus, whether or not the hybrid video export approach described above can be applied depends on whether the video format of the input video file is supported by or compatible with the container format of the exported video file.

### Example Overall Method for Intelligent Video Exporting

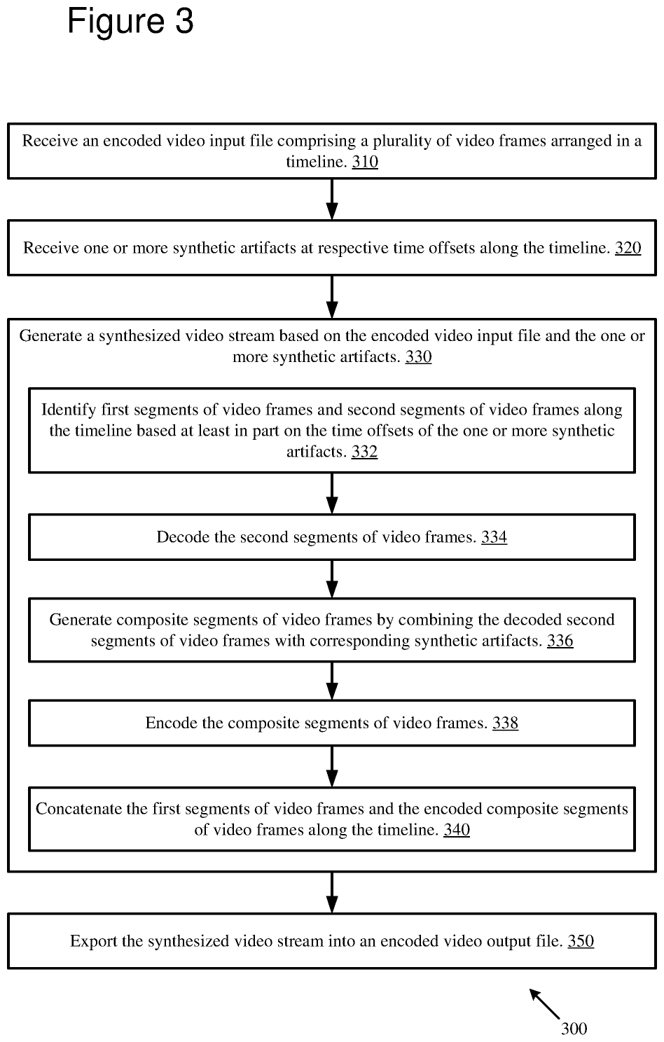

FIG. 3 is a flowchart of an example overall method 300 for intelligent video editing, and can be performed, e.g., by the system 100 of FIG. 1.

At 310, an encoded video input file including a plurality of video frames arranged in a timeline can be received. For example, the encoded video input file can be one of the video assets stored in the video asset repository 110. Referring to FIG. 2, the received video input file can be loaded into a video project 200, and the plurality of video frames can be 210 arranged in the timeline 250.

At 320, one or more synthetic artifacts at respective time offsets along the timeline can be received. For example, as illustrated in FIG. 2, the synthetic artifacts can include one or more visible objects 220 and/or visual modifiers 230 which affect or alter the visual appearance or scenes of some of the video frames when the video frames are replayed.

At 330, a synthesized video stream can be generated based on the encoded video input file and the one or more synthetic artifacts. Then, at 350, the synthesized video stream can be exported into an encoded video output file (e.g., 170).

As shown in FIG. 3, generating the synthesized video stream at 330 can include several steps.

At 332, the method 300 can identify first segments of video frames and second segments of video frames along the timeline based at least in part on the time offsets of the one or more synthetic artifacts. In some examples, as described above in reference to FIG. 2, the first segments of video frames can include video frames that are non-overlapping with the time offsets of the one or more synthetic artifacts, while the second segments of video frames can include video frames that are overlapping with the time offsets of the one or more synthetic artifacts.

At 334, the second segments of video frames can be decoded (e.g., by the decoder 130) to generate decoded second segments of video frames.

At 336, composite segments of video frames can be generated (e.g., by the compositor 140) by combining the decoded second segments of video frames with corresponding synthetic artifacts.

At 338, the composite segments of video frames can be encoded (e.g., by the encoder 150).

At 340, the first segments of video frames and the encoded composite segments of video frames can be concatenated (e.g., by the 160) along the timeline to generate the synthesized video frame. The first segments of video frames are directly extracted from the encoded video input file without being decoded.

The illustrated actions can be described from alternative perspectives while still implementing the technologies. For example, “receive” can also be described as “send” from a different perspective.

The method 300 and any of the other methods described herein can be performed by computer-executable instructions (e.g., causing a computing system to perform the method) stored in one or more computer-readable media (e.g., storage or other tangible media) or stored in one or more computer-readable storage devices. Such methods can be performed in software, firmware, hardware, or combinations thereof. Such methods can be performed at least in part by a computing system (e.g., one or more computing devices).

### Example Overall Method for Selecting Video Editing Approaches

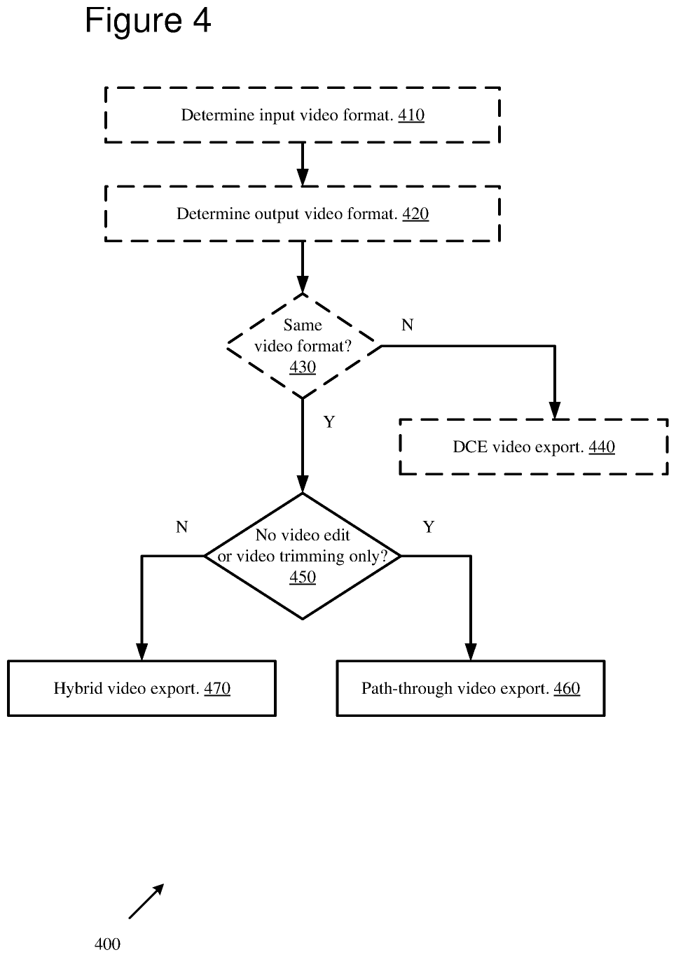

FIG. 4 is a flowchart of an example overall method 400 for determining which approach to take during video export.

At 410, the method 400 can determine an input video format of a video asset. For example, the input video format can be stored as metadata of an input video file, and can be determined by a video editor or other video readers (e.g., 120).

At 420, the method 400 can determine an output video format for an output video file. For example, a user of the video editor can select the output video format before exporting the edited video asset.

As described above, the input video format and output video format can include video container format, video codec standard, codec profiles, frame resolution, aspect ratio, frame rate, bitrate, etc.

At 430, a condition check can be performed to determine if the input video format is the same as the output video format.

If the condition check at 430 returns yes, the method 400 can proceed to 440, where all video frames of the video asset (except for trimmed video frames in trim windows) are processed through the decoder-compositor-encoder (DCE) pipeline to generate the video output file.

On the other hand, if the condition check at 430 returns no, the method 400 can proceed to 450 to perform another condition check to determine if there are any video edits to the video asset.

If there is no video edit to the video asset, or the only edits are trimming certain portions of the video asset, then the method 400 can proceed to 460, where all video frames of the original video asset (except for trimmed video frames in trim windows) are directly copied to the video output file (i.e., bypassing the DCE pipeline).

If there are certain video edits to the video asset that affect the visual experience of some of the video frames (e.g., visible objects 220 and/or visual modifiers 230, but exclude changes to the audio stream), the method 400 can proceed to 470, where the video frames (except for trimmed video frames in trim windows) can be exported to the output video file using the hybrid video export approach described above. In such circumstances, unmodified segments of the video asset can directly pass through, and these pass-through video segments can be concatenated with modified segments of the video asset (i.e., processed by the decoder-compositor-encoder pipeline) to generate a synthesized video stream, which can be saved into the video output file.

As described above, when the video format of the exported video file is more flexible, certain differences in video format between the original video asset and the exported video file may not affect the hybrid video export approach described above. In such circumstances, the steps 410, 420, 430 and 440 can be optional.

### Example Method for Segmenting Video Streams

As described above in reference to FIG. 2, video frames in a video stream along a timeline can be grouped into a plurality of segments. Specifically, one group of segments are modified segments (e.g., segments 260), which include video frames that overlap with the time offsets of visible objects or visual modifiers. Another group of segments are pass-through segments (e.g., segments 270), which include video frames that do not overlap with the time offsets of either visible objects or visual modifiers.

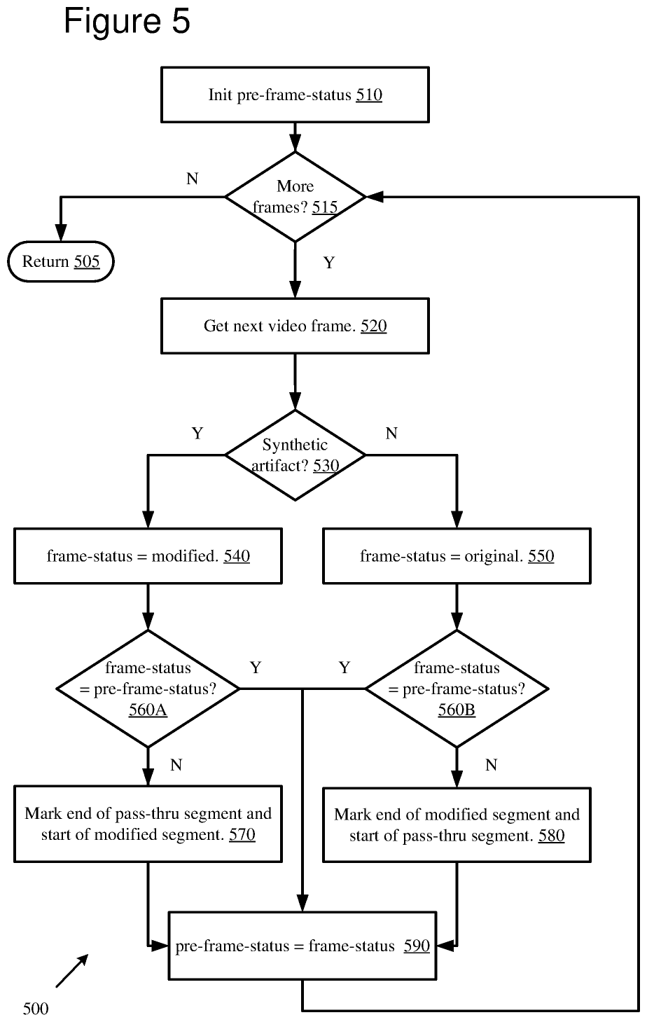

FIG. 5 is flowchart of an example method 500 for segmenting video streams. In the examples described below, an indicator, e.g., “frame-status,” is used to indicate whether a current video frame belongs to a modified segment (e.g., denoted as “modified”) or a pass-through segment (e.g., denoted as “original”). Another indicator, e.g., “pre-frame-status,” is used to indicate whether an immediately preceding video frame belongs to a modified segment or a pass-through segment.

At 510, the indicator pre-frame-status can be initialized. For example, pre-frame-status can be set to either “modified” or “original.”

At 515, the method 500 can check if more video frames in the video stream need to be processed. If not, the method 500 will return at 505. Otherwise, the method 500 proceeds to 520 to obtain the next video frame for analysis.

At 530, the method 500 checks if the current video frame is modified by any synthetic artifact. For example, the method 500 can check if any visible object or visual modifier has a time offset that is the same as the time offset of the current video frame.

If the check at 530 returns yes, the method 500 proceeds to 540 to set the indicator frame-status to “modified” (i.e., the current video frame is allocated to a modified segment).

At 560A, the method 500 further checks if the frame-status is the same as pre-frame-status (i.e., checking if the current video frame and previous video frame are in the same modified segment).

If the check at 560A returns no, the method 500 can proceed to 570, where the previous video frame is marked as the end of a pass-through segment and the current video frame is marked as the start of a new modified segment. Then, the pre-frame-status can be updated to frame-status (i.e., “modified”) at 590, and the method 500 can return to 515. If the check at 560A returns yes, the method 500 can proceed directly to 590.

If the check at 530 returns no, the method 500 proceeds to 550 to set the indicator frame-status to “original” (i.e., the current video frame is allocated to a pass-through segment).

At 560B, the method 500 further checks if the frame-status is the same as pre-frame-status (i.e., checking if the current video frame and previous video frame are in the same pass-through segment).

If the check at 560B returns no, the method 500 can proceed to 580, where the previous video frame is marked as the end of a modified segment and the current video frame is marked as the start of a new pass-through segment. Then, the pre-frame-status can be updated to frame-status (i.e., “original”) at 590, and the method 500 can return to 515. If the check at 560B returns yes, the method 500 can proceed directly to 590.

Thus, for each video frame in a video stream, the method 500 can allocate the video frame in either a modified segment or a pass-through segment (e.g., at steps 540 and 550). Additionally, the method 500 can identify the start and end of each modified segment and each pass-through segment (e.g., at steps 570 and 580).

The start and end of each segment (either a modified segment or a pass-through segment) can be initially expressed in time offsets on the timeline, and then converted to corresponding byte offsets in the video stream. Accordingly, corresponding segments of the video stream can be retrieved and routed to the decoder-compositor-encoder pipeline (for modified segments) and pass-through shortcut (for pass through segments), respectively. Based on the determined byte offsets, the segments can be concatenated into a synthesized video stream (e.g., by the concatenator 160) which can be saved into the video output file.

In some examples, conversion from the time offset to the byte offset can be performed based on a look-up table (if exist) contained in the video asset (e.g., in some media files with MP4/MOV containers), where the look-up table maps the time offset of each video frame to a corresponding byte offset in the video stream. In some examples, conversion from the time offset to the byte offset can be calculated based on certain parameters of the bitstream (e.g., frame rate, frame resolution, etc.). In certain instances, a search algorithm (e.g., linear search, binary search, etc.) can be used to find a byte offset in an encoded bitstream corresponding to any given time offset.

### Example Variations

Several variations of the hybrid video export approach can be implemented.

In the examples described above, any synthetic artifact which modifies the visual appearance or scene of a video frame will cause the video frame to be placed in a modified segment, which is processed through the decoder-compositor-encoder pipeline. In some circumstances, the criteria to allocate a video frame to a modified or pass-through segment can be altered so that more video frames can be allocated to the pass-through segment.

For example, certain video container formats support logical cropping feature by storing crop margins as per-packet metadata in the video file. The video stream can still contain full-size video frames, but the margins of the video frames can be cropped away (based on the stored crop margin metadata) when the video file is replayed by a video player supporting such video container formats. Thus, if one of such video container formats is chosen for the output video file, any margin cropping added to the video project's timeline does not need to be treated as a visual modifier. Instead, cropping margins can be specified in the metadata for relevant video frames. As a result, if a video frame is merely cropped at the margins (i.e., no other visual modifier or visible object is added to the video frame), then this video frame can be allocated to a pass-through segment, and the video data corresponding to this video frame can be copied directly to the output video file.

As another example, certain video container formats may support variable frame pacing, in addition to steady frame pacing. In steady frame pacing, every video frame has the same duration (i.e., 1/fps seconds). When playing back the video, the speedup/slow down effect can be implemented by discarding selected video frames from the input video (to speed up a video) or duplicate selected video frames of the input video (to slow down). Since such manipulation alters the sequence of video frames (thus the compression scheme), changing the playback speed can be deemed as a visual modifier. In variable frame pacing, the video frames can have variable durations. The video playback speed can be changed by keeping the number of video frames constant. For example, a video segment can be sped up or slowed down by respectively shortening or lengthening the durations of corresponding video frames. Such variable frame durations can be specified in metadata of the output video file. Thus, if the container format of the video output file supports variable frame spacing, changing playback speed does not need to be treated as a video modifier. In other words, if a video segment is merely altered in playback speed (i.e., no other visual modifier or visible object is added to the video segment), this video segment can be identified as a pass-through segment, and the video data corresponding to this video segment can be copied directly to the output video file.

In some examples, different heuristics and culling approaches can be used to identify non-occluded (or otherwise visually altered) visual representations of a video frame. For instance, it is possible to identify and cull fully occluded video segments along the video project's timeline. To illustrate, referring back to FIG. 2 which shows a variety of synthetic artifacts. Now assume that the visible objects 220 fully occlude the corresponding video frames 210. This can occur, e.g., when a user choses to overlay on top of the underlying video frames with another video asset having the same frame size as the underlying video frames. In such circumstances, the visual makeup of the video frames occluded by the visible objects 220 do not impact or contribute to the visual presentation when the output video file is replayed. Thus, if such a fully-occlusion scenario is detected, a predefined heuristic rule can be applied to directly copy segments of the overlying video asset (e.g., the visible objects 220) to the output video file, bypassing the decoding-compositing-encoding sequence even though technically the occluded video frames are part of the composite scenes.

In some examples, two or more video assets or input files can be combined in a video project and arranged sequentially along a timeline. The hybrid video export scheme described above can be applied independently to each video asset. For example, the video format of each video asset can be independently compared to the video format of the output video file, and decision can be made independently for each video asset whether or not compressed packets within the video asset can be passed through to the output video file without decoding-compositing-encoding. As described above, some video output files may support flexible video formats. In such cases, comparison of video format between the video assets and the output video file may not be needed. For example, if the output video file supports different video formats of multiple video assets that are sequentially arranged in the timeline of a video project, each video asset can be independently exported to the video output file using the hybrid export approach described above.

### Example Audio Export

Typically, the audio stream contained in a video file is processed separately from the video stream contained in the video file. For example, the audio stream can be decompressed by an audio decoder to generate a decoded video signal arranged along the timeline. An audio compositor can combine the decoded audio signal with any audio clips (e.g., 240) added to the video object to generate a composite audio signal. Then an audio encoder can encode the composite audio signal to generate an encoded audio stream in the video output file.

In some examples, a hybrid audio export approach similar to the hybrid video export approach described above can be used to export the audio stream. For example, it can be determined which segments of the audio stream contained in an input video file are modified in the video project and which segments of the audio stream are not modified in the video project. A segment of the audio stream is modified if it overlaps with an added audio clip such that both the segment of the audio stream and the added audio clip are audible at the same time (e.g., when cross-fading two audio files or when overlapping one media file with a voice track and another media file with a music track, etc.). The modified audio segments can be processed through the corresponding audio decoding-compositing-encoding sequence, and concatenated with unmodified audio segments which bypass such sequence. The concatenated data can be saved as an exported audio stream in the output video file.

Likewise, one or more audio format compatibility criteria can be used to determine whether segments of an input audio stream can be directly copied to the exported audio stream or the whole input video stream needs to be processed through the decoding-compositing-encoding sequence. Such audio format compatibility criteria can include comparison of audio formats between the input video stream and the exported audio stream, such as the number of audio channels (e.g., one for mono, two for stereo, 5+1 or 7+1 for different surround types, etc.), the audio channel layout (e.g., mono, stereo, 5.1, 7.1, etc.), the audio sampling frequency (e.g., 44,100, 48,000 Hz, etc.), the audio volume, etc.

### Example Advantages

A number of advantages can be achieved via the technology described herein. For example, the intelligent video export system described herein can divide a video project's timeline into modified segments which are processed by conventional decoder-compositor-encoder pipeline and pass-through segments which can be directly copied to the output video file. Such a hybrid video export scheme can maximize the aggregate duration of all timeline intervals that can be passed through to the output video stream (e.g., copying segments of compressed video assets on the timeline directly into the output video file). The intelligent video export system described herein can also take advantage of features offered by certain video container formats (e.g., logical cropping, variable frame pacing, flexible video format, etc.) to further maximize the portions of pass-through segments and improve the efficiency of video export, as described above. Accordingly, the decoding-compositing-encoding sequence is invoked only when necessary (e.g., due to certain synthetic artifacts and/or incompatible video format), whereas a significant portion of the video asset can take the shortcut path and skip the resource-intensive decoding-compositing-encoding sequence. As a result, the intelligent video export system described herein can improve the operating efficiency, reduce the resource (e.g., power and memory) consumption, and lower the end-to-end video export time.

### Computing Systems

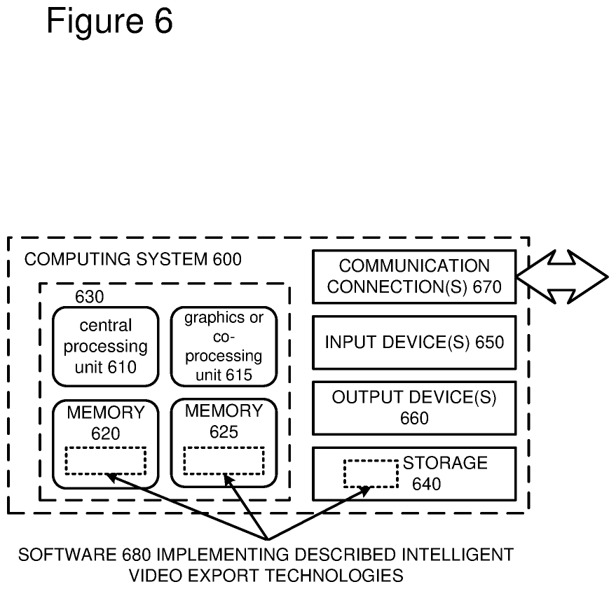

FIG. 6 depicts a generalized example of a suitable computing system 600 in which the described technologies may be implemented. The computing system 600 is not intended to suggest any limitation as to scope of use or functionality, as the technologies may be implemented in diverse general-purpose or special-purpose computing systems.

With reference to FIG. 6, the computing system 600 includes one or more processing units 610, 615 and memory 620, 625. In FIG. 6, this basic configuration 630 is included within a dashed line. The processing units 610, 615 execute computer-executable instructions. A processing unit can be a general-purpose central processing unit (CPU), processor in an application-specific integrated circuit (ASIC), or any other type of processor. A processing unit can also comprise multiple processors. In a multi-processing system, multiple processing units execute computer-executable instructions to increase processing power. For example, FIG. 6 shows a central processing unit 610 as well as a graphics processing unit or co-processing unit 615. The tangible memory 620, 625 may be volatile memory (e.g., registers, cache, RAM), non-volatile memory (e.g., ROM, EEPROM, flash memory, etc.), or some combination of the two, accessible by the processing unit(s). The memory 620, 625 stores software 680 implementing one or more technologies described herein, in the form of computer-executable instructions suitable for execution by the processing unit(s).

A computing system may have additional features. For example, the computing system 600 includes storage 640, one or more input devices 650, one or more output devices 660, and one or more communication connections 670. An interconnection mechanism (not shown) such as a bus, controller, or network interconnects the components of the computing system 600. Typically, operating system software (not shown) provides an operating environment for other software executing in the computing system 600, and coordinates activities of the components of the computing system 600.

The tangible storage 640 may be removable or non-removable, and includes magnetic disks, magnetic tapes or cassettes, CD-ROMs, DVDs, or any other medium which can be used to store information and which can be accessed within the computing system 600. The storage 640 stores instructions for the software 680 implementing one or more technologies described herein.

The input device(s) 650 may be a touch input device such as a keyboard, mouse, pen, or trackball, a voice input device, a scanning device, or another device that provides input to the computing system 600. For video encoding, the input device(s) 650 may be a camera, video card, TV tuner card, or similar device that accepts video input in analog or digital form, or a CD-ROM or CD-RW that reads video samples into the computing system 600. The output device(s) 660 may be a display, printer, speaker, CD-writer, or another device that provides output from the computing system 600.

The communication connection(s) 670 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The technologies can be described in the general context of computer-executable instructions, such as those included in program modules, being executed in a computing system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

### Mobile Device

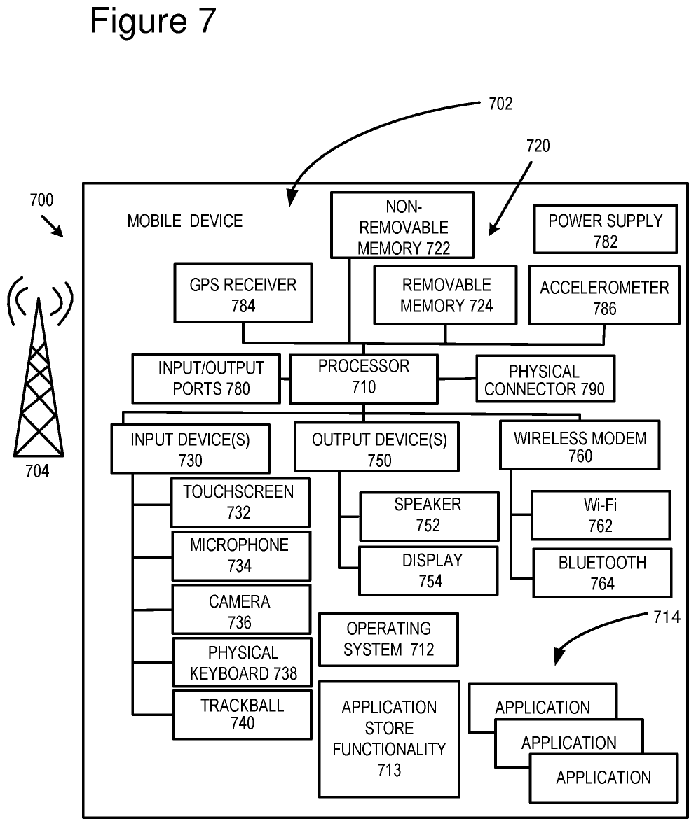

FIG. 7 is a system diagram depicting an example mobile device 700 including a variety of optional hardware and software components, shown generally at 702, in which described embodiments, techniques, and technologies may be implemented. Any components 702 in the mobile device can communicate with any other component, although not all connections are shown, for ease of illustration. The mobile device can be any of a variety of computing devices (e.g., cell phone, smartphone, handheld computer, Personal Digital Assistant (PDA), etc.) and can allow wireless two-way communications with one or more mobile communications networks 704, such as a cellular, satellite, or other network.

The illustrated mobile device 700 can include a controller or processor 710 (e.g., signal processor, microprocessor, ASIC, or other control and processing logic circuitry) for performing such tasks as signal coding, data processing, input/output processing, power control, and/or other functions. An operating system 712 can control the allocation and usage of the components 702 and support for one or more application programs 714. The application programs can include common mobile computing applications (e.g., email applications, calendars, contact managers, web browsers, messaging applications), or any other computing application. Functionality 713 for accessing an application store can also be used for acquiring and updating application programs 714. The application programs 714 can also include applications related to video processing, such as acquiring video assets, editing video assets, and exporting video assets. Specifically, one or more of the application programs 714 can be configured for implementing the intelligent video export technologies described herein.

The illustrated mobile device 700 can include memory 720. Memory 720 can include non-removable memory 722 and/or removable memory 724. The non-removable memory 722 can include RAM, ROM, flash memory, a hard disk, or other well-known memory storage technologies. The removable memory 724 can include flash memory or a Subscriber Identity Module (SIM) card, which is well known in GSM communication systems, or other well-known memory storage technologies, such as “smart cards.” The memory 720 can be used for storing data and/or code for running the operating system 712 and the applications 714. Example data can include web pages, text, images, sound files, video data, or other data sets to be sent to and/or received from one or more network servers or other devices via one or more wired or wireless networks. The memory 720 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

The mobile device 700 can support one or more input devices 730, such as a touchscreen 732, microphone 734, camera 736, physical keyboard 738 and/or trackball 740 and one or more output devices 750, such as a speaker 752 and a display 754. Other possible output devices (not shown) can include piezoelectric or other haptic output devices. Some devices can serve more than one input/output function. For example, touchscreen 732 and display 754 can be combined in a single input/output device.

The input devices 730 can include a Natural User Interface (NUI). An NUI is any interface technology that enables a user to interact with a device in a “natural” manner, free from artificial constraints imposed by input devices such as mice, keyboards, remote controls, and the like. Examples of NUI methods include those relying on speech recognition, touch and stylus recognition, gesture recognition both on screen and adjacent to the screen, air gestures, head and eye tracking, voice and speech, vision, touch, gestures, and machine intelligence. Other examples of a NUI include motion gesture detection using accelerometers/gyroscopes, facial recognition, 3D displays, head, eye, and gaze tracking, immersive augmented reality and virtual reality systems, all of which provide a more natural interface, as well as technologies for sensing brain activity using electric field sensing electrodes (EEG and related methods). Thus, in one specific example, the operating system 712 or applications 714 can comprise speech-recognition software as part of a voice user interface that allows a user to operate the device 700 via voice commands. Further, the device 700 can comprise input devices and software that allows for user interaction via a user's spatial gestures, such as detecting and interpreting gestures to provide input to a gaming application.

A wireless modem 760 can be coupled to an antenna (not shown) and can support two-way communications between the processor 710 and external devices, as is well understood in the art. The modem 760 is shown generically and can include a cellular modem for communicating with the mobile communication network 704 and/or other radio-based modems (e.g., Bluetooth 764 or Wi-Fi 762). The wireless modem 760 is typically configured for communication with one or more cellular networks, such as a GSM network for data and voice communications within a single cellular network, between cellular networks, or between the mobile device and a public switched telephone network (PSTN).

The mobile device can further include at least one input/output port 780, a power supply 782, a satellite navigation system receiver 784, such as a Global Positioning System (GPS) receiver, an accelerometer 786, and/or a physical connector 790, which can be a USB port, IEEE 1394 (FireWire) port, and/or RS-232 port. The illustrated components 702 are not required or all-inclusive, as any components can be deleted and other components can be added.

### Cloud-Supported Environment

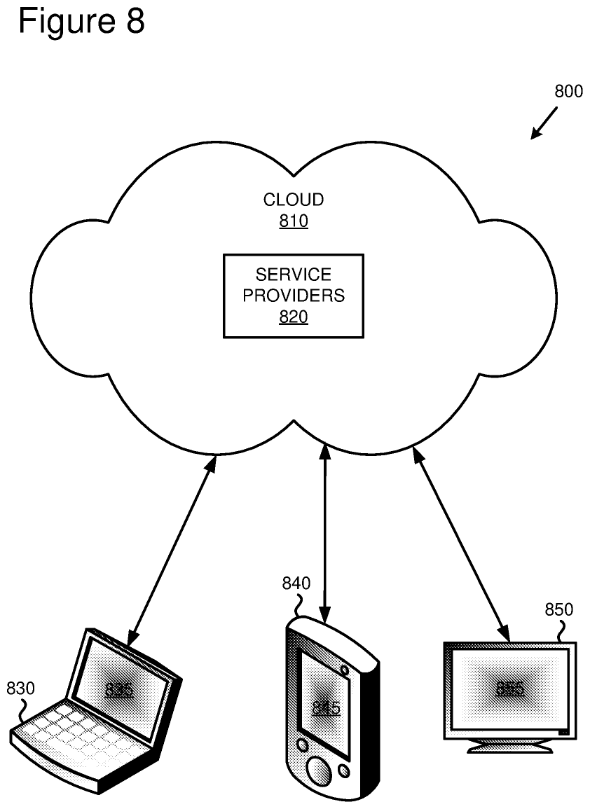

FIG. 8 illustrates a generalized example of a suitable cloud-supported environment 800 in which described embodiments, techniques, and technologies may be implemented. In the example environment 800, various types of services (e.g., computing services) are provided by a cloud 810. For example, the cloud 810 can comprise a collection of computing devices, which may be located centrally or distributed, that provide cloud-based services to various types of users and devices connected via a network such as the Internet. The implementation environment 800 can be used in different ways to accomplish computing tasks. For example, some tasks (e.g., processing user input and presenting a user interface) can be performed on local computing devices (e.g., connected devices 830, 840, 850) while other tasks (e.g., storage of data to be used in subsequent processing) can be performed in the cloud 810.

In example environment 800, the cloud 810 provides services for connected devices 830, 840, 850 with a variety of screen capabilities. Connected device 830 represents a device with a computer screen 835 (e.g., a mid-size screen). For example, connected device 830 could be a personal computer such as desktop computer, laptop, notebook, netbook, or the like. Connected device 840 represents a device with a mobile device screen 845 (e.g., a small size screen). For example, connected device 840 could be a mobile phone, smart phone, personal digital assistant, tablet computer, and the like. Connected device 850 represents a device with a large screen 855. For example, connected device 850 could be a television screen (e.g., a smart television) or another device connected to a television (e.g., a set-top box or gaming console) or the like. One or more of the connected devices 830, 840, 850 can include touchscreen capabilities. Touchscreens can accept input in different ways. For example, capacitive touchscreens detect touch input when an object (e.g., a fingertip or stylus) distorts or interrupts an electrical current running across the surface. As another example, touchscreens can use optical sensors to detect touch input when beams from the optical sensors are interrupted. Physical contact with the surface of the screen is not necessary for input to be detected by some touchscreens. Devices without screen capabilities also can be used in example environment 800. For example, the cloud 810 can provide services for one or more computers (e.g., server computers) without displays.

Services can be provided by the cloud 810 through service providers 820, or through other providers of online services (not depicted). For example, cloud services can be customized to the screen size, display capability, and/or touchscreen capability of a particular connected device (e.g., connected devices 830, 840, 850).

In example environment 800, the cloud 810 provides the technologies and solutions described herein to the various connected devices 830, 840, 850 using, at least in part, the service providers 820. For example, the service providers 820 can provide a centralized solution for various cloud-based services. The service providers 820 can manage service subscriptions for users and/or devices (e.g., for the connected devices 830, 840, 850 and/or their respective users).

### Example Implementations

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media and executed on a computing device (i.e., any available computing device, including smart phones or other mobile devices that include computing hardware). Computer-readable storage media are tangible media that can be accessed within a computing environment (one or more optical media discs such as DVD or CD, volatile memory (such as DRAM or SRAM), or nonvolatile memory (such as flash memory or hard drives)). By way of example and with reference to FIG. 6, computer-readable storage media include memory 620 and 625, and storage 640. The term computer-readable storage media does not include signals and carrier waves. In addition, the term computer-readable storage media does not include communication connections, such as 670.

Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub combinations with one another. The disclosed methods, apparatus, and systems are not limited to any specific aspect or feature or combination thereof, nor do the disclosed embodiments require that any one or more specific advantages be present or problems be solved.

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology.

As described in this application and in the claims, the singular forms “a,” “an,” and “the” include the plural forms unless the context clearly dictates otherwise. Additionally, the term “includes” means “comprises.” Further, “and/or” means “and” or “or,” as well as “and” and “or.”

### Example Embodiments

Any of the following example embodiments can be implemented.

Example 1. A computer-implemented method comprising: receiving an encoded video input file comprising a plurality of video frames arranged in a timeline; receiving one or more video artifacts at respective time offsets along the timeline, wherein the one or more video artifacts change visual appearance of the video frames at the respective time offsets when the video frames are replayed; generating a synthesized video stream based on the encoded video input file and the one or more video artifacts; and exporting the synthesized video stream into an encoded video output file, wherein generating the synthesized video stream comprises: identifying first segments of video frames and second segments of video frames along the timeline based at least in part on the time offsets of the one or more video artifacts; decoding the second segments of video frames; generating composite segments of video frames by combining the decoded second segments of video frames with corresponding video artifacts; encoding the composite segments of video frames; and concatenating the first segments of video frames and the encoded composite segments of video frames along the timeline to generate the synthesized video stream, wherein the first segments of video frames are directly extracted from the encoded video input file without being decoded.

Example 2. The method of example 1, wherein the one or more video artifacts comprise a filter applied to a selected video frame.

Example 3. The method of any one of examples 1-2, wherein the one or more video artifacts comprise a cropping operator applied to a selected video frame.

Example 4. The method of any one of examples 1-3, wherein the one or more video artifacts comprise a change of playback speed for one or more video frames.

Example 5. The method of any one of examples 1-4, wherein the one or more video artifacts comprise a graphic object occluding at least a portion of a selected video frame.

Example 6. The method of any one of examples 1-5, wherein the first segments of video frames are non-overlapping with the time offsets of the one or more video artifacts and the second segments of video frames are overlapping with the time offsets of the one or more video artifacts.

Example 7. The method of example 6, further comprising: identifying trimmed video frames that overlap with a specified trim window; and removing trimmed video frames from the first and second segments of video frames.

Example 8. The method of any one of examples 1-7, wherein the identifying comprises: determining a first video format of the encoded video input file; determining a second video format of the encoded video output file; comparing the first video format with the second video format; responsive to finding that the first video format is different from the second video format, setting the first segments to null and placing the plurality of video frames into the second segments.

Example 9. The method of example 8, wherein the first and second video formats comprise one or more of frame resolution, aspect ratio, codec standard, codec profile, frame rate, and bitrate.

Example 10. The method of any one of examples 1-9, wherein the encoded video input file is a first encoded video input file comprising a plurality of first video frames arranged in a first timeline, the one or more video artifacts are first video artifacts, and the synthesized video stream is a first synthesized video frame, the method further comprising: receiving a second encoded video input file comprising a plurality of second video frames arranged in a second timeline; receiving one or more second video artifacts at respective time offsets along the second timeline; generating a second synthesized video stream based on the second encoded video input file and the one or more second video artifacts; and exporting both the first synthesized video stream and the second synthesized video stream into the encoded video output file, wherein the first encoded video input file has a first video format, the second encoded video input file has a second video format, the first video format being different from the second video format.

Example 11. A computing device comprising: memory; one or more hardware processors coupled to the memory; and one or more computer readable storage media storing instructions that, when loaded into the memory, cause the one or more hardware processors to perform operations comprising: receiving an encoded video input file comprising a plurality of video frames arranged in a timeline; receiving one or more video artifacts at respective time offsets along the timeline, wherein the one or more video artifacts change visual appearance of the video frames at the respective time offsets when the video frames are replayed; generating a synthesized video stream based on the encoded video input file and the one or more video artifacts; and exporting the synthesized video stream into an encoded video output file, wherein generating the synthesized video stream comprises: identifying first segments of video frames and second segments of video frames along the timeline based at least in part on the time offsets of the one or more video artifacts; decoding the second segments of video frames; generating composite segments of video frames by combining the decoded second segments of video frames with corresponding video artifacts; encoding the composite segments of video frames; and concatenating the first segments of video frames and the encoded composite segments of video frames along the timeline to generate the synthesized video stream, wherein the first segments of video frames are directly extracted from the encoded video input file without being decoded.

Example 12. The computing device of example 11, wherein the one or more video artifacts comprise a filter applied to a selected video frame.

Example 13. The computing device of any one of examples 11-12, wherein the one or more video artifacts comprise a cropping operator applied to a selected video frame.

Example 14. The computing device of any one of examples 11-13, wherein the one or more video artifacts comprise a change of playback speed for one or more video frames.

Example 15. The computing device of any one of examples 11-14, wherein the one or more video artifacts comprise a graphic object occluding at least a portion of a selected video frame.

Example 16. The computing device of any one of examples 11-15, wherein the first segments of video frames are non-overlapping with the time offsets of the one or more video artifacts and the second segments of video frames are overlapping with the time offsets of the one or more video artifacts.

Example 17. The computing device of example 16, wherein the operations further comprise: identifying trimmed video frames that overlap with a specified trim window; and removing trimmed video frames from the first and second segments of video frames.

Example 18. The computing device of any one of examples 11-17, wherein the identifying comprises: determining a first video format of the encoded video input file; determining a second video format of the encoded video output file; comparing the first video format with the second video format; responsive to finding that the first video format is different from the second video format, setting the first segments to null and placing the plurality of video frames into the second segments.

Example 19. The computing device of example 18, wherein the first and second video formats comprise one or more of frame resolution, aspect ratio, codec standard, codec profile, frame rate, and bitrate.

Example 20. One or more non-transitory computer-readable media having encoded thereon computer-executable instructions causing one or more processors to perform a method comprising: receiving an encoded video input file comprising a plurality of video frames arranged in a timeline; receiving one or more video artifacts at respective time offsets along the timeline, wherein the one or more video artifacts change visual appearance of the video frames at the respective time offsets when the video frames are replayed; generating a synthesized video stream based on the encoded video input file and the one or more video artifacts; and exporting the synthesized video stream into an encoded video output file, wherein generating the synthesized video stream comprises: identifying first segments of video frames and second segments of video frames along the timeline based at least in part on the time offsets of the one or more video artifacts; in a first signal path, decoding the second segments of video frames, generating composite segments of video frames by combining the decoded second segments of video frames with corresponding video artifacts, and encoding the composite segments of video frames; in a second signal path, retrieving the first segments of video frames directly from the encoded video input file without decoding the same; and concatenating, along the timeline, the first segments of video frames retrieved from the second signal path and the encoded composite segments of video frames output from the first signal path to generate the synthesized video stream.

### Example Alternatives

The technologies from any example can be combined with the technologies described in any one or more of the other examples. In view of the many possible embodiments to which the principles of the disclosed technology can be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

What is claimed is:

1. A computer-implemented method comprising:
receiving an encoded video input file comprising a plurality of video frames arranged in a timeline;
receiving one or more video artifacts at respective time offsets along the timeline, wherein the one or more video artifacts change visual appearance of the video frames at the respective time offsets when the video frames are replayed;
generating a synthesized video stream based on the encoded video input file and the one or more video artifacts; and
exporting the synthesized video stream into an encoded video output file,
wherein generating the synthesized video stream comprises:
identifying first segments of video frames and second segments of video frames along the timeline based at least in part on the time offsets of the one or more video artifacts;
decoding the second segments of video frames;
generating composite segments of video frames by combining the decoded second segments of video frames with corresponding video artifacts;
encoding the composite segments of video frames; and
concatenating the first segments of video frames and the encoded composite segments of video frames along the timeline to generate the synthesized video stream, wherein the first segments of video frames are directly extracted from the encoded video input file without being decoded.

2. The method of claim 1, wherein the one or more video artifacts comprise a filter applied to a selected video frame.

3. The method of claim 1, wherein the one or more video artifacts comprise a cropping operator applied to a selected video frame.

4. The method of claim 1, wherein the one or more video artifacts comprise a change of playback speed for one or more video frames.

5. The method of claim 1, wherein the one or more video artifacts comprise a graphic object occluding at least a portion of a selected video frame.

6. The method of claim 1, wherein the first segments of video frames are non-overlapping with the time offsets of the one or more video artifacts and the second segments of video frames are overlapping with the time offsets of the one or more video artifacts.

7. The method of claim 6, further comprising:
identifying trimmed video frames that overlap with a specified trim window; and
removing trimmed video frames from the first and second segments of video frames.

8. The method of claim 1, wherein the identifying comprises:
determining a first video format of the encoded video input file;
determining a second video format of the encoded video output file;
comparing the first video format with the second video format;
responsive to finding that the first video format is different from the second video format, setting the first segments to null and placing the plurality of video frames into the second segments.

9. The method of claim 8, wherein the first and second video formats comprise one or more of frame resolution, aspect ratio, codec standard, codec profile, frame rate, and bitrate.

10. The method of claim 1, wherein the encoded video input file is a first encoded video input file comprising a plurality of first video frames arranged in a first timeline, the one or more video artifacts are first video artifacts, and the synthesized video stream is a first synthesized video frame, the method further comprising:
receiving a second encoded video input file comprising a plurality of second video frames arranged in a second timeline;
receiving one or more second video artifacts at respective time offsets along the second timeline;
generating a second synthesized video stream based on the second encoded video input file and the one or more second video artifacts; and
exporting both the first synthesized video stream and the second synthesized video stream into the encoded video output file,
wherein the first encoded video input file has a first video format, the second encoded video input file has a second video format, the first video format being different from the second video format.

11. A computing device comprising:
memory;
one or more hardware processors coupled to the memory; and
one or more computer readable storage media storing instructions that, when loaded into the memory, cause the one or more hardware processors to perform operations comprising:
receiving an encoded video input file comprising a plurality of video frames arranged in a timeline;
receiving one or more video artifacts at respective time offsets along the timeline, wherein the one or more video artifacts change visual appearance of the video frames at the respective time offsets when the video frames are replayed;
generating a synthesized video stream based on the encoded video input file and the one or more video artifacts; and
exporting the synthesized video stream into an encoded video output file,
wherein generating the synthesized video stream comprises:
identifying first segments of video frames and second segments of video frames along the timeline based at least in part on the time offsets of the one or more video artifacts;
decoding the second segments of video frames;
generating composite segments of video frames by combining the decoded second segments of video frames with corresponding video artifacts;
encoding the composite segments of video frames; and
concatenating the first segments of video frames and the encoded composite segments of video frames along the timeline to generate the synthesized video stream, wherein the first segments of video frames are directly extracted from the encoded video input file without being decoded.

12. The computing device of claim 11, wherein the one or more video artifacts comprise a filter applied to a selected video frame.

13. The computing device of claim 11, wherein the one or more video artifacts comprise a cropping operator applied to a selected video frame.

14. The computing device of claim 11, wherein the one or more video artifacts comprise a change of playback speed for one or more video frames.

15. The computing device of claim 11, wherein the one or more video artifacts comprise a graphic object occluding at least a portion of a selected video frame.

16. The computing device of claim 11, wherein the first segments of video frames are non-overlapping with the time offsets of the one or more video artifacts and the second segments of video frames are overlapping with the time offsets of the one or more video artifacts.

17. The computing device of claim 16, wherein the operations further comprise:
identifying trimmed video frames that overlap with a specified trim window; and
removing trimmed video frames from the first and second segments of video frames.

18. The computing device of claim 11, wherein the identifying comprises:
determining a first video format of the encoded video input file;
determining a second video format of the encoded video output file;
comparing the first video format with the second video format;
responsive to finding that the first video format is different from the second video format, setting the first segments to null and placing the plurality of video frames into the second segments.

19. The computing device of claim 18, wherein the first and second video formats comprise one or more of frame resolution, aspect ratio, codec standard, codec profile, frame rate, and bitrate.

20. One or more non-transitory computer-readable media having encoded thereon computer-executable instructions causing one or more processors to perform a method comprising:
receiving an encoded video input file comprising a plurality of video frames arranged in a timeline;
receiving one or more video artifacts at respective time offsets along the timeline, wherein the one or more video artifacts change visual appearance of the video frames at the respective time offsets when the video frames are replayed;
generating a synthesized video stream based on the encoded video input file and the one or more video artifacts; and
exporting the synthesized video stream into an encoded video output file,
wherein generating the synthesized video stream comprises:
identifying first segments of video frames and second segments of video frames along the timeline based at least in part on the time offsets of the one or more video artifacts;
in a first signal path,
decoding the second segments of video frames;
generating composite segments of video frames by combining the decoded second segments of video frames with corresponding video artifacts; and
encoding the composite segments of video frames;
in a second signal path, retrieving the first segments of video frames directly from the encoded video input file without decoding the same; and
concatenating, along the timeline, the first segments of video frames retrieved from the second signal path and the encoded composite segments of video frames output from the first signal path to generate the synthesized video stream.
